(19) United States
(12) Patent Application Publication
(10) Pub. No.: US 2019/0126827 A1
(43) Pub. Date: May 2, 2019

(54) IMAGE GENERATING APPARATUS AND PROGRAM

(71) Applicant: DENSO CORPORATION, Kariya-city, Aichi-pref. (JP)

(72) Inventors: Masayuki AMAGAI, Kariya-city, Aichi-pref. (JP); Muneaki MATSUMOTO, Kariya-city, Aichi-pref. (JP); Nobuyuki YOKOTA, Kariya-city, Aichi-pref. (JP)

(21) Appl. No.: 16/308,956

(22) PCT Filed: Jun. 13, 2017
(86) PCT No.: PCT/JP2017/021855

§ 371 Date: Dec. 11, 2018

(30) Foreign Application Priority Data
Jun. 13, 2016 (JP) 2016-117010

(51) Int. Cl. B60R 1/00; H04N 5/272; H04N 5/262

(52) U.S. Cl. CPC B60R 1/00; H04N 5/272; H04N 5/2628; B60R 2300/105; B60R 2300/305; B60R 2300/8086; B60R 2300/60

(57) ABSTRACT

An image generation unit generates images showing a vehicle and the vicinity from a virtual viewpoint set outside the vehicle using the vicinity of the vehicle acquired by image acquisition units. A path estimation unit estimates a driving path of the vehicle on the basis of a driving state of the vehicle. An image synthesis unit processes either one of images of the vehicle among the images generated by the image generation unit or an image of the estimated driving path into a transparent image, and superimposing the transparent image over another one of the images and an image of the vicinity among the images generated by the image generation unit.

### CROSS-REFERENCE TO RELATED APPLICATION

This international application is based upon and claims priority of the prior Japanese Patent Application No. 2016-117010, filed at the Japan Patent Office on Jun. 13, 2016, the entire contents of which are incorporated herein by reference.

### TECHNICAL FIELD

The present disclosure relates to a technique to generate an image in accordance with a vehicle and the vicinity of the vehicle.

### BACKGROUND ART

PTL 1 below describes a technique to generate, via a vehicle mounted camera, images showing the own vehicle and the vicinity of the vehicle from a virtual viewpoint set outside the vehicle on the basis of an image of the vicinity of the vehicle acquired and an image of a roof of the vehicle or the like prepared in advance. The virtual viewpoint is a virtually set viewpoint and such a viewpoint set, for example, obliquely above the vehicle or the like in a three-dimensional space including the entire vehicle allows understanding of the relationship between the vehicle and the situation in the vicinity.

### CITATION LIST

### Patent Literature

[PTL 1] WO 00/07373

### SUMMARY OF THE INVENTION

Meanwhile, a technique is also known to display, in reversing of a vehicle and the like, a driving path of the vehicle estimated from the steering angle and the like superimposed on an acquired image of the rear vicinity of the vehicle. However, as a result of detailed investigations by the inventor, in the technique described in PTL 1, a problem was found that display of images showing a vehicle and the vicinity of the vehicle from a virtual viewpoint (hereinafter, may be referred to as a 3D view) simply superimposed on the driving path produces an image that is difficult to recognize.

In one aspect of the present disclosure, it is desired to allow recognition of both images showing a vehicle and the vicinity of the vehicle from a virtual viewpoint and an estimated driving path of the vehicle.

Another aspect of the present disclosure is an image generating apparatus including image acquisition units, an image generation unit, a path estimation unit, and an image synthesis unit.

The image acquisition units are configured to acquire an image of the surroundings of a vehicle. The image generation unit is configured to generate images showing the vehicle and the vicinity from a virtual viewpoint set outside the vehicle using the image acquired by the image acquisition units. The path estimation unit is configured to estimate a driving path of the vehicle on the basis of a driving state of the vehicle. The image synthesis unit is configured to generate an image, as an output image, obtained by processing either one of the images of the vehicle among images generated by the image generation unit or an image of the driving path estimated by the path estimation unit to a transparent image, and superimposing the transparent image on another one of the images, further superimposing these images over an image of the vicinity among the images generated by the image generation unit.

According to such configuration, either an image representing the vehicle among the images showing the vehicle and the vicinity from the virtual viewpoint or an image of the estimated driving path of the vehicle is processed into a transparent image to be superimposed on the other image. These images are then superimposed over the image of the vicinity, and thus both the images showing the vehicle and the vicinity of the vehicle from the virtual viewpoint and the estimated driving path of the vehicle become recognizable. As a result, it is possible to understand easily both the relationship between the vehicle and the situation in the vicinity and the relationship between the driving path estimated for the vehicle and the situation in the vicinity.

In another aspect of the present disclosure, the image generation unit is configured to generate images showing the vehicle spuriously provided with transparency and the vicinity from a virtual viewpoint (V) set outside the vehicle using the image acquired by the image acquisition units and transparent images (B, T) of the vehicle prepared in advance in accordance with the vehicle. The image synthesis unit is configured to generate an image, as an output image, obtained by superimposing images of the vehicle among images generated by the image generation unit over an image (K) of the driving path estimated by the path estimation unit and further superimposing these images over an image (H) of the vicinity among the images generated by the image generation unit.

In this case as well, an image obtained by superimposing the transparent vehicle image over the path image is superimposed over the image of the vicinity, and thus both images showing the vehicle and the vicinity of the vehicle from a virtual viewpoint and the estimated driving path of the vehicle become recognizable. As a result, it becomes possible to understand easily both the relationship between the vehicle and the situation in the vicinity and the relationship between the driving path estimated for the vehicle and the situation in the vicinity.

The reference signs in parentheses described in the appended claims represent correspondence with specific mechanisms described in the embodiments described later as individual modes and do not limit the technical scope of the present disclosure.

### BRIEF DESCRIPTION OF DRAWINGS

FIG. 1 is a block diagram illustrating configuration of an image generating apparatus in a first embodiment;

FIG. 2 is an illustrative diagram schematically representing arrangement of cameras in the image generating apparatus;

FIG. 3 is a flowchart illustrating displaying process performed by the image generating apparatus;

FIG. 4 is an illustrative diagram representing an example of a display result by the display process;

FIG. 5 is a block diagram illustrating configuration of an image generating apparatus in a second embodiment;

FIG. 6 is an illustrative diagram representing an example of a state of display in the image generating apparatus;

FIG. 7 is a flowchart illustrating displaying process performed by the image generating apparatus;

FIG. 8 is an illustrative diagram representing an alteration of the virtual viewpoint in the display process;

FIG. 9 is an illustrative diagram representing another alteration of the virtual viewpoint in the display process;

FIG. 10 is an illustrative diagram representing a modification of a driving path display in a respective embodiment; and

FIG. 11 is an illustrative diagram representing another modification of a driving path display in a respective embodiment.

### DESCRIPTION OF EMBODIMENTS

With reference to the drawings, some embodiments will be described below. A transparent image herein means an image in which part of the image is processed to be transparent or all or part of the image is processed to be semitransparent and does not include an image in which the entire image is processed to be transparent so as not to allow recognition of the image.

### 1. First Embodiment

[1-1. Configuration]

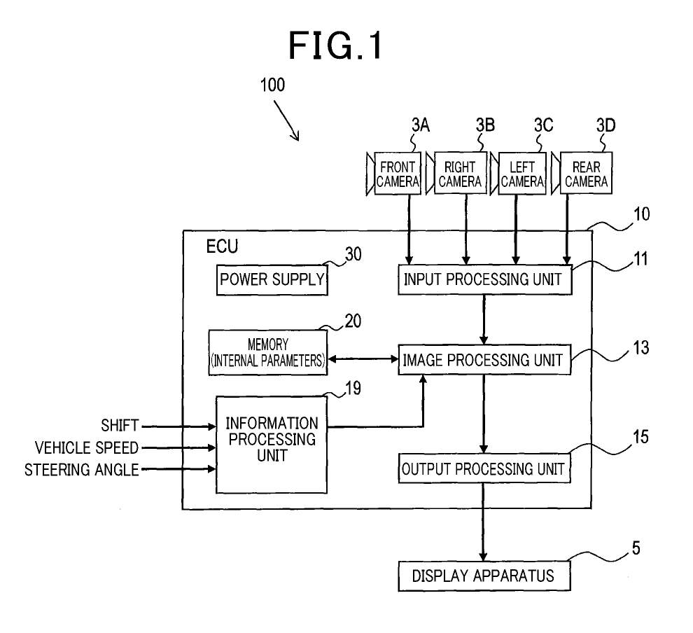

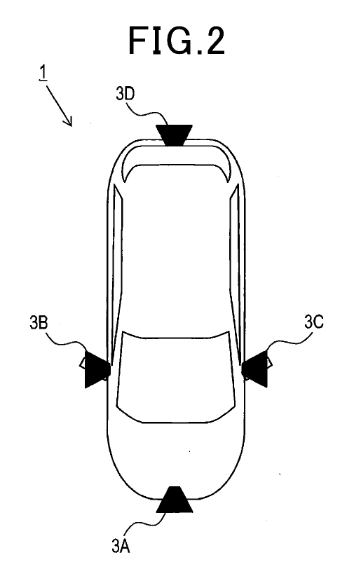

FIG. 1 illustrates an image generating apparatus 100 in the first embodiment including cameras 3A to 3D, a display apparatus 5, and an ECU 10. As illustrated in FIG. 1, the camera 3A is a front camera 3A, the camera 3B is a right camera 3B, the camera 3C is a left camera 3C, and the camera 3D is a rear camera 3D. The image generating apparatus 100 is mounted on a vehicle 1 illustrated in FIG. 2, and the front camera 3A, the right camera 3B, the left camera 3C, and the rear camera 3D are installed respectively at the front of the vehicle 1, on the right of the vehicle 1, on the left of the vehicle 1, and at the rear of the vehicle 1. The front camera 3A may be arranged, for example, at the front-end center of a hood of the vehicle 1. The rear camera 3D may be arranged, for example, above a license plate at the rear of the vehicle 1. The right camera 3B and the left camera 3C may be arranged, for example, respectively above right and left side mirrors. Any of the cameras 3A to 3D may be wide angle cameras.

As the display apparatus 5, various display apparatuses are available, such as those using liquid crystal and those using organic EL devices. The display apparatus 5 may be a monochrome display apparatus or a color display apparatus. The display apparatus 5 may be configured as a touch screen by being provided with piezoelectric devices and the like on the surface. The display apparatus 5 may be used also as a display apparatus provided for another on-board device, such as a car navigation system and an audio device.

The ECU 10 is mainly configured with a known microcomputer having a CPU, not shown, and a semiconductor memory (hereinafter, a memory 20) such as a RAM, a ROM, and a flash memory. Various functions of the ECU 10 are achieved by causing the CPU to execute programs stored in a non-transitory readable storage medium. In this example, the memory 20 is equivalent to the non-transitory readable storage medium storing programs. Execution of such a program causes execution of a method corresponding to the program. The number of microcomputers configuring the ECU 10 may be one or a plurality. The ECU 10 is provided with a power supply 30 to maintain memory of the RAM in the memory 20 and to drive the CPU.

The ECU 10 includes, as configuration of the functions achieved by causing the CPU to execute the program, a camera video input processing unit (hereinafter, an input processing unit) 11, an image processing unit 13, a video output signal processing unit (hereinafter, an output processing unit) 15, and a vehicle information signal processing unit (hereinafter, an information processing unit) 19. A technique to achieve these elements configuring the ECU 10 is not limited to software and all or part of the elements may be achieved using hardware combining a logic circuit, an analog circuit, and the like.

The input processing unit 11 accepts input of a signal in accordance with video captured by the cameras 3A to 3D from the cameras 3A to 3D and converts the signal to a signal allowed to be handled as image data in the ECU 10. The image processing unit 13 applies working process described later (hereinafter, referred to as display process) to the signal inputted from the input processing unit 11 and outputs the processed signal to the output processing unit 15. The output processing unit 15 generates a signal to drive the display apparatus 5 in accordance with the signal inputted from the image processing unit 13 and outputs the generated signal to the display apparatus 5. The information processing unit 19 acquires data (hereinafter, may be referred to as vehicle information), such as a shift position, a vehicle speed, and a steering angle of the vehicle 1, via an in-vehicle LAN, not shown, and the like and outputs the data to the image processing unit 13. A driving state of the vehicle means a state of the vehicle represented by the vehicle information. The memory 20 stores, in addition to the program, internal parameters representing an outer shape and the like of a roof and the like of the vehicle 1.

[1-2. Process]

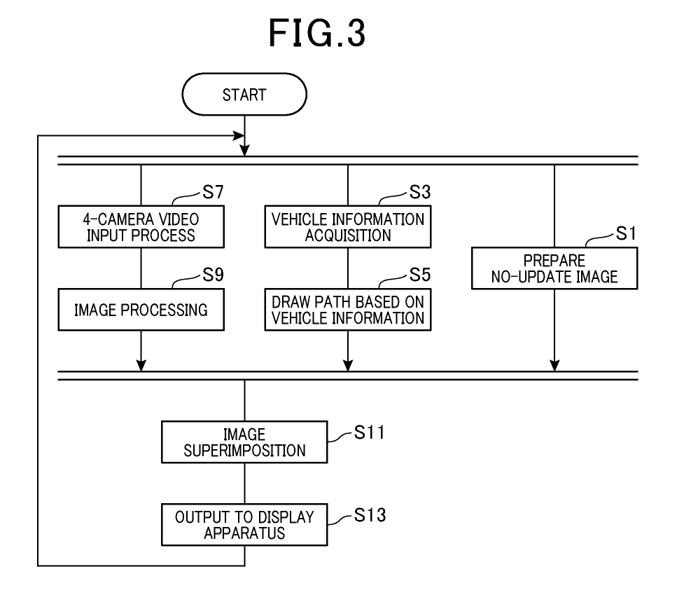

A description is then given to display process executed by the image processing unit 13 with reference to the flowchart in FIG. 3. The present process starts when a predetermined operation is conducted by a driver while the power supply of the vehicle 1 is turned on. The predetermined operation may be an operation to set the shift position to R (i.e., reversing), may be an operation to press a switch or a button for starting the display process, or may be another operation. The power supply of the vehicle 1 being turned on means a state of the power switch literally being turned on when the vehicle 1 is an electric vehicle or a hybrid vehicle and means a state of the key arranged in a position of ACC or ON when the vehicle 1 is a vehicle driven by an internal combustion engine.

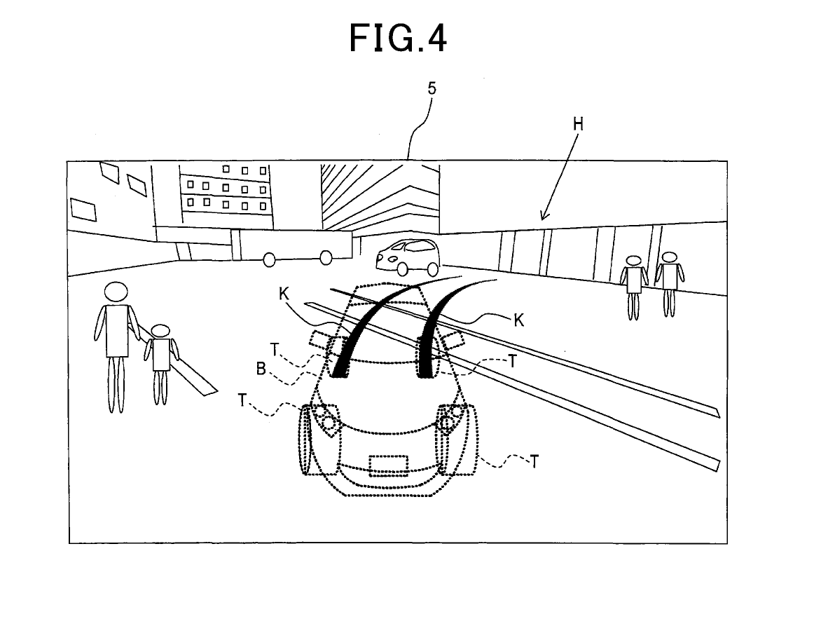

As illustrated in FIG. 3, upon start of the present process, process at S1, process at S3 and S5, and process at S7 and S9 are executed as parallel processing. The process at S1 prepares an image requiring no update, such as the shape of the roof of the vehicle 1. The present process is conducted by reading appropriate data from the memory 20. For example, when a 3D view of seeing the vehicle 1 and the vicinity from a virtual viewpoint arranged obliquely above the front of the vehicle 1 is displayed on the display apparatus 5 by the present process, the shape of a vehicle body B of the vehicle 1 is a shape, for example, exemplified with dotted lines in FIG. 4 and requires no update. At S1, data of such an image is prepared.

In the process at S3 and S5, firstly at S3, the vehicle information, such as a shift position, a vehicle speed, and a steering angle, is acquired, and at following S5, a path of the vehicle 1 is drawn on the basis of the vehicle information. In the process at S5, a driving path (hereinafter, may be referred to simply as a path) of the vehicle 1 is estimated on the basis of the vehicle information acquired at S3 and the path is drawn, for example, in an image buffer provided in the memory 20. The path drawn at S5 may be a path of the entire vehicle body B of the vehicle 1, may be a path of all wheels T, or may be a path of the rear wheels T (i.e., path of part of wheels T) as a path K exemplified in FIG. 4. At S5 here, on the basis of the steering angle and the like acquired as the vehicle information at S3, an angle (i.e., an orientation) of each wheel T to the vehicle body B may be calculated to draw the wheels T at the angle in the image buffer.

In the process at S7 and S9, firstly at S7, image data in accordance with video captured by the four cameras 3A, 3B, 3C, and 3D is inputted to the input processing unit 11, and at following S9, image processing to the image data is conducted to synthesize an image of a 3D view of seeing the vicinity of the vehicle 1 from a virtual viewpoint. For example, at S9, video captured by the four cameras 3A, 3B, 3C, and 3D is transformed and combined to synthesize an image as exemplified as a background H in FIG. 4. In this situation, for the vehicle body B or the wheels T in a photography range of the cameras 3A to 3D, such as a side of the vehicle 1, an image may be synthesized on the basis of the photographed result or an image in accordance with data prepared in advance at S1 may be used at following S11.

In such a manner, when the process at S1, the process at S3 and S5, and the process at S7 and S9 are executed respectively as parallel processing, the process proceeds to S11 to superimpose the images generated in the respective process as parallel processing. In this situation, simple superimposition of each image causes the majority of the path K to be covered with the vehicle body B, resulting in display of the path K only in the distance. In this case, it is difficult for driver of the vehicle 1 to assume the movement of the vehicle 1 at close range.

At S11, while an image of the path K drawn at S5 can be superimposed directly on an image of the background H generated at S9, an image of the wheels T and the vehicle body B is processed to be semitransparent or partially processed to be transparent to allow superimposition over the images of the background H and the path K. The form of such process to produce semitransparent or transparent is considered to be various forms.

For example, the image of the wheels T and the vehicle body B may be processed to be an image representing the outlines with dotted lines as exemplified in FIG. 4 to be superimposed on the images of the background H and the path K. That is, the image of the wheels T and the vehicle body B may be processed to be an image in which the portions other than the outlines are processed to be completely transparent for superimposition. The outlines may be in solid lines, dash dotted lines, or the like. At S11, so-called alpha blending may be performed in which the image of the wheels T and the vehicle body B is superimposed over the images of the background H and the path K for synthesis by setting a predetermined degree of transparency (i.e., an alpha value) for each pixel representing the wheels T and the vehicle body B. The setting of the degree of transparency corresponds to the process to produce semitransparency. Such process to produce semitransparent or transparent may be applied to part of the wheels T and the vehicle body B to the extent allowing recognition of the path K. Only the vehicle body B may be processed to be transparent or semitransparent while the wheels T are subjected to neither process to produce transparent nor process to produce semitransparent. The process at S11 may process the image of the path K to be semitransparent or transparent as described above and superimposes the processed image over the image of the wheels T and the vehicle body B. An image itself of the part of the vehicle body B that does not influence the driving operation may be omitted.

The data corresponding to the image thus finished with the superimposition by S11 is outputted at following S13 to the display apparatus 5 via the output processing unit 15, and the process proceeds to the parallel processing described above (i.e., S1, S3, S7).

[1-3. Effects]

According to the first embodiment described in detail above, the following effects are obtained.

(1A) In the present embodiment, either image of the image of the vehicle body B and the image of the estimated path K of the vehicle among the 3D view image taken from the virtual viewpoint is processed to be semitransparent or transparent (i.e., provided with transparency) at least in part, and superimposed on the other image. As a result, an image allowing good recognition of both the image of the vehicle body B and the image of the path K is displayed on the display apparatus 5. These images are superimposed on the image of the background H and thus allow good understanding of both relationship between the vehicle 1 and the situation in the vicinity and relationship between the path K estimated for the vehicle 1 and the situation in the vicinity. Accordingly, the driver of the vehicle 1 is capable of readily estimate movement of his/her vehicle (i.e., the vehicle 1). The driver can also well understand estimated movement of his/her vehicle from short to long distances that used to be difficult.

(1B) In the example illustrated in FIG. 4, a 3D view taken from the virtual viewpoint arranged obliquely above the front of the vehicle 1 is displayed on the display apparatus 5. In this case, in reversing of the vehicle 1, both the relationship between the vehicle 1 and the situation in the vicinity and the relationship between the path K estimated for the vehicle 1 and the situation in the vicinity are allowed to be understood extremely well. A virtual viewpoint arranged obliquely above the vehicle 1 causes a greater overlap between the vehicle body B and the path K in comparison with that arranged upward direction of the vehicle 1. Accordingly, as described above, the effects of processing either the vehicle body B or the path K to be semitransparent or transparent are exhibited even more significantly.

(1C) As exemplified in FIG. 4, when a 3D view of the wheels T and the vehicle body B is displayed and at least the vehicle body B is processed to be semitransparent or transparent and further an angle of each wheel T to the vehicle body B is an angle in accordance with the steering angle, relationship between the steering angle and the path K is readily understood. Accordingly, the driver is allowed to well understand how the estimated path K changes by controlling the steering angle in what way.

In the above embodiment, the front camera 3A, the right camera 3B, the left camera 3C, and the rear camera 3D correspond to the image acquisition units, and the ECU 10 corresponds to the image generation unit, the path estimation unit, and the image synthesis unit. Among the process by the ECU 10, S1 and S9 are process corresponding to the image generation unit, S5 to the path estimation unit, and S10 to the image synthesis unit.

### 2. Second Embodiment

[2-1. Differences to First Embodiment]

The second embodiment has a basic configuration the same as that of the first embodiment, and thus descriptions are omitted for the configuration in common to mainly describe the differences. The same reference signs as the first embodiment indicate identical configuration and refer to the preceding descriptions.

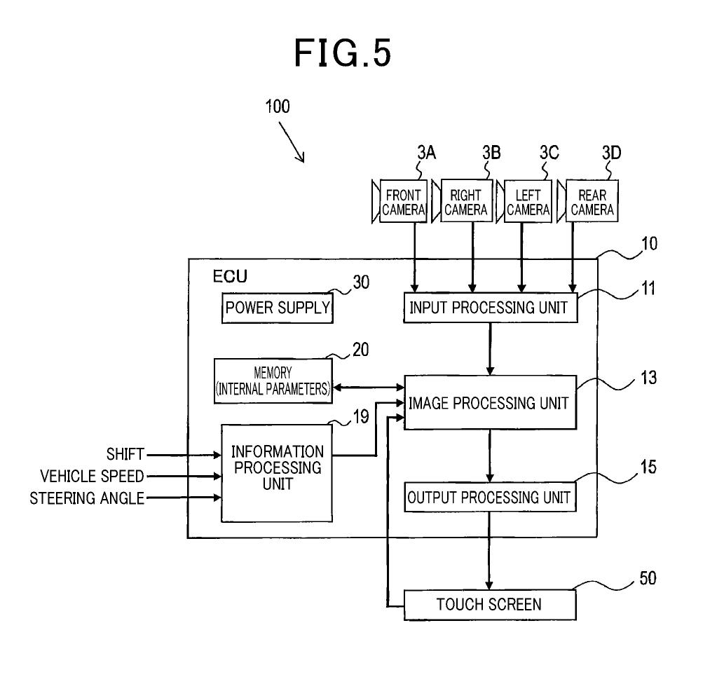

In the first embodiment described above, the display apparatus 5 may have functions only for display or may be a touch screen. In contrast, the second embodiment is different from the first embodiment in that, as illustrated in FIG. 5, a touch screen 50 is used as the display apparatus 5 and a signal representing the state of operation is inputted to the image processing unit 13.

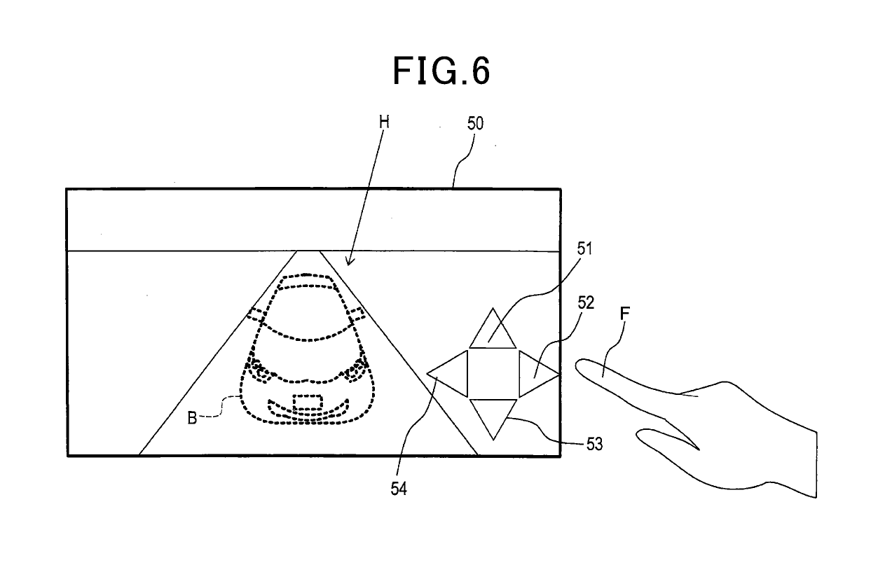

On the touch screen 50, in display of a 3D view, arrow buttons 51 to 54 as illustrated in FIG. 6 are displayed. The arrow button 51 is a button to move the virtual viewpoint upward. The arrow button 52 is a button to move the virtual viewpoint rightward. The arrow button 53 is a button to move the virtual viewpoint downward. The arrow button 54 is a button to move the virtual viewpoint leftward. When any of the arrow buttons 51 to 54 is pressed by a finger F, the information is inputted to the image processing unit 13.

Although in FIG. 6 the arrow buttons 51 to 54 are arranged in the lower right corner of the touch screen 50, they are not limited to this configuration and may be arranged in any mode as long as they do not interfere with the driver viewing the 3D view. For example, the buttons may be arranged in any corner of upper or lower and left or right or if being displayed in a mode not to hide the 3D view by being processed to be semitransparent or the like, may be displayed at the center of the touch screen 50.

[2-2. Process]

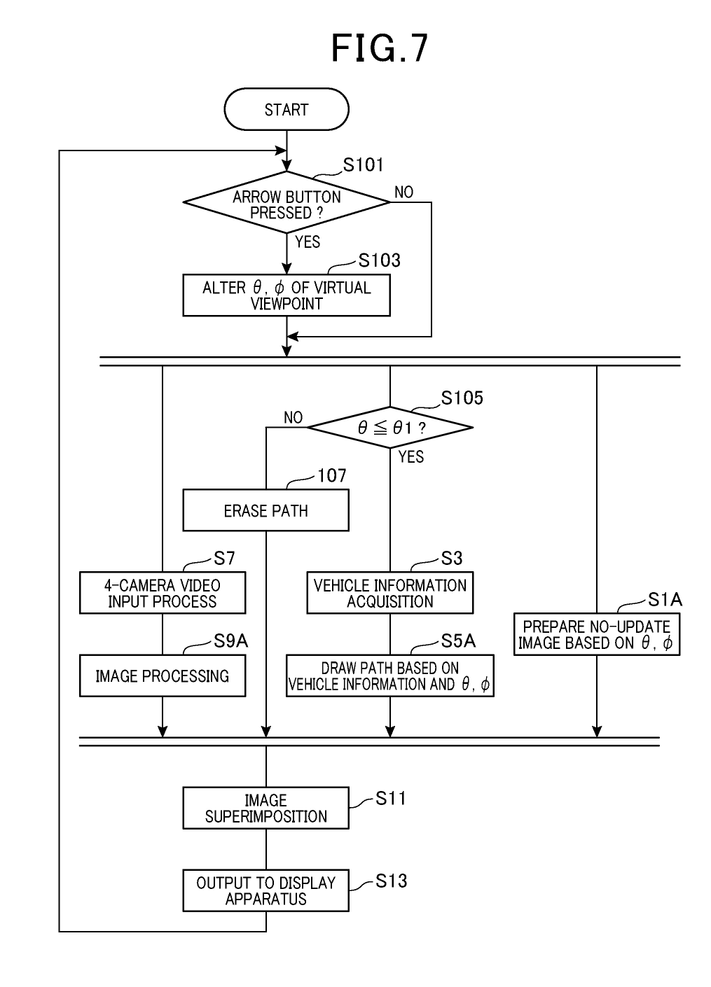

A description is then given to display process executed by the image processing unit 13 in the second embodiment, instead of the display process in the first embodiment illustrated in FIG. 3, with reference to the flowchart in FIG. 7. The process illustrated in FIG. 7 is different from the process in FIG. 3 in that process from S101 to S107 is added, and in accordance with the difference, the process at S1, S5, S9 is slightly altered to be S1A, SSA, S9A. Such alterations are described below.

In the present display process, at the start of the process and at the end of the process at S13, the process at S101 is executed. At S101, whether any of the arrow buttons 51 to 54 is pressed is determined.

If the determination is made that any of the arrow buttons 51 to 54 is pressed (i.e., Yes), the process proceeds to S103. At S103, θ or φ in polar coordinates of the virtual viewpoint is altered in accordance with the pressed one among the arrow buttons 51 to 54.

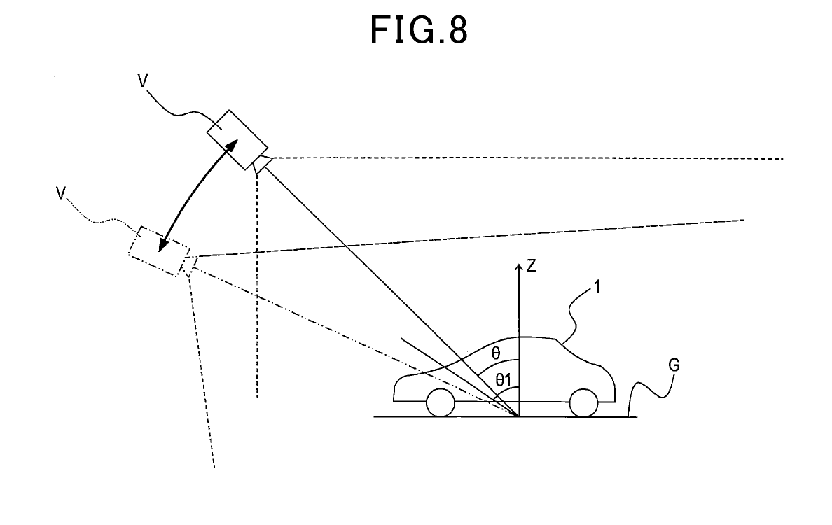

For example, as illustrated in FIG. 8, an upward axis perpendicular to the ground G (e.g., a road surface) supporting the vehicle 1 through the center of the vehicle 1 is defined as a Z axis, and an angle of inclination (i.e., a deflection angle) of the virtual viewpoint V relative to the Z axis is defined to be θ. At S103, the position of the virtual viewpoint V is altered to decrease ° when the arrow button 51 is pressed and the position of the virtual viewpoint V is altered to increase ° when the arrow button 53 is pressed. The value ° may be altered in a range of 0°≤0≤90°, and if the arrow button 51 or 53 is pressed to alter ° exceeding the available range, the pressing is ignored.

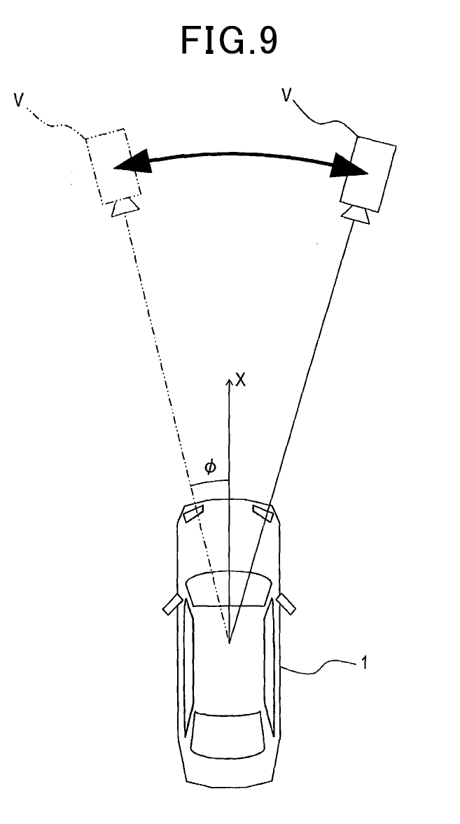

For example, as illustrated in FIG. 9, an axis directed to the front of the vehicle 1 through the center of the vehicle 1 is defined as an X axis, and an azimuth measured counterclockwise in plan view from the X axis is defined as φ. At S103, the position of the virtual viewpoint V is altered to increase φ when the arrow button 52 is pressed, and the position of the virtual viewpoint V is altered to decrease φ when the arrow button 54 is pressed. The value φ may be altered in a range of −180°≤φ≤+180°, and if the arrow button 52 or 54 is pressed to alter φ exceeding the range, process of equating −180° with +180° is conducted.

After finishing the process at S103 or if the determination is made that none of the arrow buttons 51 to 54 is pressed (i.e., No) at S101, process at S1A, process at S105 and S107 and S3 and S5A, and process at S7 and S9A are executed as parallel processing.

At S1A, different from S1 in the first embodiment, on the basis of θ and φ set at S103, an image requiring no update, such as the shape of the roof of the vehicle 1, is prepared in accordance with the position of the virtual viewpoint V set at this timing. Similarly at S9A, different from S9 in the first embodiment, on the basis of θ and φ set at S103, image processing is performed to synthesize an image of a 3D view taken from the virtual viewpoint V set at this timing.

At S105 inserted to one step earlier than S3 in the first embodiment, whether θ is 01, set as a threshold in advance, or less is determined. The value θ1 represents an angle of reducing the reason for displaying the image of the path K because the image is displayed with almost no vertical dimension and the value is set, for example, at an angle exemplified in FIG. 8.

If the determination is made at S105 that θ is greater than θ1, the image of the path K drawn by that moment is erased at S107, and the process proceeds to S11 described above. If the determination is made at S105 that θ is θ1 or less, the process proceeds to S3 same as the first embodiment to acquire the vehicle information. At S5A following S3, different from S5 in the first embodiment, on the basis of θ and φ set at S103, the path K is drawn in a shape taken from the virtual viewpoint V set at this timing.

[2-3. Effects]

According to the second embodiment described in detail above, in addition to the effects (1A) to (1C) described above in the first embodiment, the following effects are obtained.

(2A) In the present embodiment, pressing of the arrow buttons 51 to 54 allows free control of the position of the virtual viewpoint V. Accordingly, both the relationship between the vehicle 1 and the situation in the vicinity and the relationship between the path K estimated for the vehicle 1 and the situation in the vicinity are allowed to be displayed well from the virtual viewpoint V arranged in a position desired by the driver. In other words, both the relationship between the vehicle 1 and the situation in the vicinity and the relationship between the path K estimated for the vehicle 1 and the situation in the vicinity are allowed to be understood well from the angle viewed by the driver.

(2B) When the position of the virtual viewpoint V is low (i.e., θ has a greater value) and display of the path K taken from the position has less meaning, the path K is not displayed. Accordingly, it is possible to suppress useless process in the image processing unit 13. The value θ1 to be such a threshold whether to display the path K may be set at an appropriate angle during production or may be set at an angle desired by the driver, and for example, may be set in accordance with a criterion, such as an angle of a line connecting a front end of the roof and the center of a rear wheel in the vehicle 1. In the second embodiment, the arrow buttons 51 to 54 correspond to the viewpoint setting units.

### 3. Other Embodiments

Embodiments to carry out the present disclosure have been described above while the present disclosure may be performed in various modifications without limited to the embodiments described above.

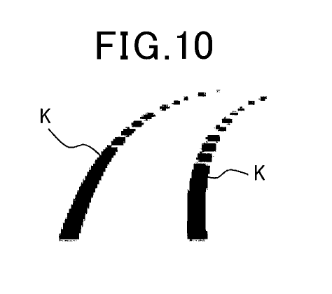

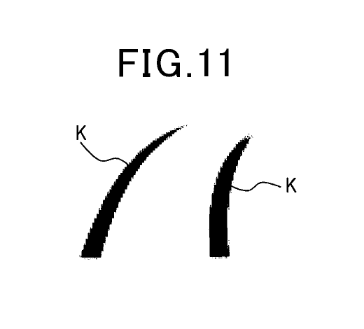

(3A) Although the path K in the example in FIG. 4 is drawn solidly in a single color, the present disclosure is not limited to this configuration. The mode of drawing of the path K may change in respective portions in accordance with reliability of the path K. For example, as exemplified in FIG. 10, a low reliability portion (e.g., portions distant from the vehicle 1) of the path K may be drawn with a broken line and a lower reliability may be represented by a broken line with a wider gap. As exemplified in FIG. 11, the path K may be drawn as an image with a gradation to represent a low reliability portion by a lighter color. In this case, instead of changing the depth of color, the color may be changed. Such process is achieved by calculating, when the path is estimated at S5 or S5A, reliability in the estimate for each portion of the path as well and altering the mode of drawing of the respective parts of the path K in accordance with the reliability. In this case, the driver can easily recognize the reliability in respective portions of the path K.

(3B) Although the position of the virtual viewpoint V is altered by pressing of the arrow buttons 51 to 54 in the second embodiment, the present disclosure is not limited to this configuration. For example, the position of the virtual viewpoint V may be automatically controlled to have a greater θ for a greater speed of the vehicle 1. In this case, for example, when the virtual viewpoint V is arranged obliquely above the front of the vehicle 1, a greater speed of reversing the vehicle 1 allows display of a background H at longer distance. In this case, the touch screen 50 does not have to be used and the block diagram becomes the same as that in the first embodiment. Such a process is achieved by determination at S101 in FIG. 9 whether the vehicle speed is changed, and if the vehicle speed is changed, altering the value of θ in accordance with the vehicle speed at S103.

(3C) Although the wheels T and the vehicle body B are displayed and the angle of the wheels T to the vehicle body B is at a value in accordance with the steering angle in the respective embodiments above, the present disclosure is not limited to this configuration. For example, the angle of the wheels T to the vehicle body B may be a fixed value and the wheels T do not have to be displayed. If the wheels T are not displayed, the image may be converted not to cause the driver to feel discomfort by, for example, converting the image of hiding the wheels T with the vehicle body B by a method such as computer graphics.

(3D) Although the virtual viewpoint is fixedly arranged obliquely above the front of the vehicle 1 in the first embodiment, the arrangement for fixedly arranging the virtual viewpoint is not limited to this configuration. For example, the virtual viewpoint may be fixedly arranged upward direction of the vehicle 1 or may be fixedly arranged in another position, such as obliquely above the rear and obliquely above the right of the vehicle 1.

(3E) Although a 3D view image is generated using the four cameras 3A to 3D provided in the vehicle 1 in the respective embodiments above, the present disclosure is not limited to this configuration. For example, the cameras to be used may be five or more. Even when only one camera provided in the vehicle 1 is used, a 3D view image can be sometimes generated using an image taken in the past. By employing the following configuration, no camera provided in the vehicle 1 may be used at all. For example, a 3D view may be generated using a camera provided in other than the vehicle 1, such as cameras provided in the infrastructure, cameras provided in another vehicle, and cameras provided in an event data recorder and the like mounted on another vehicle. In such a case, the image processing unit 13 acquires the image taken by the camera through communication and the like. In this case, a receiving apparatus to acquire the image by communication and the like from outside the vehicle 1 corresponds to the image acquisition units.

(3F) Although either image of the image of the vehicle body B among the 3D view image and the image of the estimated path K of the vehicle is provided with transparency and superimposed over the other image at S11 in the respective embodiments above, the present disclosure is not limited to this configuration. For example, if the image of the vehicle body B and the like prepared at S1 or S1A is an image already provided with sufficient transparency during the storage in the memory 20 (i.e., an originally transparent image), such image may be simply superimposed on the image of the vicinity H at S11.

(3G) A plurality of functions belonging to one component in the above embodiments may be achieved by a plurality of components, or one function belonging to one component may be achieved by a plurality of components. A plurality of functions belonging to a plurality of components may be achieved by one component, or one function achieved by a plurality of components may be achieved by one component. The configuration in the above embodiments may be partially omitted. The configuration in the above embodiments at least in part may be added or substituted to configuration in another of the above embodiments. Any mode included in the technical spirit specified only by the appended claims is an embodiment of the present disclosure.

(3H) In addition to the image generating apparatus 100 described above, the present disclosure may be achieved in various forms, such as a system having the image generating apparatus 100 as a component, a program for causing a computer to function as the image generating apparatus 100, a non-transitory readable storage medium such as a semiconductor memory storing such a program, and an image generation method.

### 4. Appendix

As clearly seen from the exemplified embodiments described above, the image generating apparatus 100 of the present disclosure may further include the following configuration.

(4A) The image generation unit may be configured to generate images showing the entire vehicle and the vicinity of the vehicle from a virtual viewpoint set obliquely above the vehicle. In this case, the effects of providing either the image of the vehicle or the estimated driving path as a transparent image are exhibited even more significantly.

(4B) The images of the vehicle superimposed over the image of the vicinity by the image synthesis unit may be an image processed by superimposing the image (B) of a vehicle body of the vehicle over the image (T) of each wheel of the vehicle and the image of the vehicle body may be an image provided with transparency. In this case, the image of the vehicle body is a transparent image and thus the orientation of the wheels becomes recognizable, thereby facilitating understanding of the relationship between the steering angle and the driving path.

(4C) The viewpoint setting units (51, 52, 53, 54) may be further included that are configured to set a position of the virtual viewpoint. In this case, the relationship between the vehicle and the situation in the vicinity and the relationship between the estimated driving path and the situation in the vicinity can be easily recognized from a desired angle.

(4D) In the case of (4C), when the virtual viewpoint is set via the viewpoint setting units in a position to have an angle of inclination relative to upward direction of the vehicle greater than a predetermined value set in advance, the path estimation unit (10, 5A) may be configured not to estimate the driving path and the image synthesis unit may be configured to directly use an image, as an output image, generated by the image generation unit (10, S9A, S1). In this case, it is possible to suppress useless process in the path estimation unit and the image synthesis unit. The “upward direction of” herein is not strictly limited to the opposite direction to the gravity and does not have to be strictly upward direction of as long as exhibiting the intended effects. For example, as in the second embodiment, it may be vertical to the ground G or may be slightly tilted further in any direction.

(4E) The path estimation unit may be configured to calculate reliability of the estimate for each portion of the driving path, and the image synthesis unit may be configured to superimpose an image of each portion in the driving path as an image in a mode in accordance with the reliability on the images generated by the image generation unit. In this case, the reliability of each portion in the driving path is allowed to be recognized well.

1.-9. (canceled)

10. An image generating apparatus comprising:
image acquisition units configured to acquire an image of the surroundings of a vehicle;
an image generation unit configured to generate images showing the vehicle and the vicinity from a virtual viewpoint set outside the vehicle using the image acquired by the image acquisition units;
a path estimation unit configured to estimate a driving path of the vehicle on the basis of a driving state of the vehicle; and
an image synthesis unit configured to generate an image, as an output image, obtained by processing either one of images of the vehicle among images generated by the image generation unit or an image of the driving path estimated by the path estimation unit into a transparent image, and superimposing the transparent image on another one of the images, further superimposing these images over an image of the vicinity among the images generated by the image generation unit.

11. An image generating apparatus comprising:
image acquisition units configured to acquire an image of the surroundings of a vehicle;
an image generation unit configured to generate images showing the vehicle provided with transparency and the vicinity from a virtual viewpoint set outside the vehicle using the image acquired by the image acquisition units and transparent images of the vehicle prepared in advance in accordance with the vehicle;
a path estimation unit configured to estimate a driving path of the vehicle on the basis of a driving state of the vehicle; and
an image synthesis unit configured to generate an image, as an output image, obtained by superimposing images of the vehicle among images generated by the image generation unit over an image of the driving path estimated by the path estimation unit and further superimposing these images over an image of the vicinity among the images generated by the image generation unit.

12. The image generating apparatus according to claim 10, wherein
the path estimation unit is configured to estimate a driving path of each wheel of the vehicle.

13. The image generating apparatus according to claim 11, wherein
the path estimation unit is configured to estimate a driving path of each wheel of the vehicle.

14. The image generating apparatus according to claim 10, wherein
the image generation unit is configured to generate images showing the entire vehicle and the vicinity of the vehicle from the virtual viewpoint set obliquely above the vehicle.

15. The image generating apparatus according to claim 11, wherein
the image generation unit is configured to generate images showing the entire vehicle and the vicinity of the vehicle from the virtual viewpoint set obliquely above the vehicle.

16. The image generating apparatus according to claim 10, wherein
the images of the vehicle superimposed over the image of the vicinity by the image synthesis unit are an image processed by superimposing an image of a vehicle body of the vehicle over an image of each wheel of the vehicle, and
the image of the vehicle body is an image provided with transparency.

17. The image generating apparatus according to claim 11, wherein
the images of the vehicle superimposed over the image of the vicinity by the image synthesis unit are an image processed by superimposing an image of a vehicle body of the vehicle over an image of each wheel of the vehicle, and
the image of the vehicle body is an image provided with transparency.

18. The image generating apparatus according to claim 10, further comprising:
viewpoint setting units configured to set a position of the virtual viewpoint.

19. The image generating apparatus according to claim 11, further comprising:
viewpoint setting units configured to set a position of the virtual viewpoint.

20. The image generating apparatus according to claim 18, wherein
when the virtual viewpoint is set via the viewpoint setting units in a position to have an angle of inclination relative to upward direction of the vehicle greater than a predetermined value set in advance, the path estimation unit is configured not to estimate the driving path and the image synthesis unit is configured to directly use an image, as an output image, generated by the image generation unit.

21. The image generating apparatus according to claim 19, wherein
when the virtual viewpoint is set via the viewpoint setting units in a position to have an angle of inclination relative to upward direction of the vehicle greater than a predetermined value set in advance, the path estimation unit is configured not to estimate the driving path and the image synthesis unit is configured to directly use an image, as an output image, generated by the image generation unit.

22. The image generating apparatus according to claim 10, wherein
the path estimation unit is configured to calculate reliability of the estimate for each portion of the driving path, and
the image synthesis unit is configured to superimpose an image of each portion in the driving path as an image in a mode in accordance with the reliability on the images generated by the image generation unit.

23. The image generating apparatus according to claim 11, wherein
the path estimation unit is configured to calculate reliability of the estimate for each portion of the driving path, and
the image synthesis unit is configured to superimpose an image of each portion in the driving path as an image in a mode in accordance with the reliability on the images generated by the image generation unit.

24. A non-transitory computer-readable storage medium containing instructions for causing a computer to:
generate images, using an image of vicinity of a vehicle acquired, showing the vehicle and the vicinity from a virtual viewpoint set outside the vehicle;
estimate a driving path of the vehicle on the basis of a driving state of the vehicle; and
generate an image, as an output image, obtained by processing either images of the vehicle among the generated images or an image of the estimated driving path into a transparent image, and superimposing the transparent image on the other image, further superimposing these images over an image of the vicinity among the generated images.

25. A non-transitory computer-readable storage medium containing instructions for causing a computer to:
generate images, using an image of vicinity of a vehicle acquired and transparent images of the vehicle prepared in advance in accordance with the vehicle, of seeing the vehicle provided with transparency and the vicinity from a virtual viewpoint set outside the vehicle;
estimate a driving path of the vehicle on the basis of a driving state of the vehicle; and
generate an image, as an output image, obtained by superimposing an image of the vehicle among the generated images over an image of the estimated driving path, further superimposing these images over an image of the vicinity among the generated images.
